(19) United States
(12) Patent Application Publication
(10) Pub. No.: US 2013/0158972 A1
(43) Pub. Date: Jun. 20, 2013

(54) Automated Recovery System Verification

(71) Applicant: Malcolm Linn Fry, JR., Bogart, GA (US)

(72) Inventor: Malcolm Linn Fry, JR., Bogart, GA (US)

(73) Assignee: Southern Company Services, Inc., Atlanta, GA (US)

(21) Appl. No.: 13/325,686

(22) Filed: Dec. 14, 2011

(51) Int. Cl. G06F 17/50

(52) U.S. Cl. 703/14

(57) ABSTRACT

Disclosed are various embodiments for simulating distribution electric circuit models containing simulated software intelligent electronic devices. The distribution circuit and intelligent electronic simulator application facilitates the creation of user created software intelligent electronic devices. The software intelligent electronic devices imitate the operation of actual intelligent electronic devices on a power line. Communication between the software intelligent electronic devices and the automated recovery system can be captured using the distribution circuit and intelligent electronic device simulator application.

### BACKGROUND

Power lines may fail for variety of reasons, such as, for example, power station faults, damage to electric transmission lines, damage to the distribution system, a short circuit, electricity overloads, and/or other causes of electrical power loss. As a result of a power failure, outages may last a few seconds or a few days. Even a momentary power failure can result in monetary loss, loss of life, loss of communication, and/or other losses. Due to the interconnectivity of power systems, failures in one location may often result in failures at other locations thousands of miles away.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of networked environment according to various embodiments of the present disclosure.

FIGS. 2A-2C are drawings of examples of user interfaces rendered by a client in the networked environment of FIG. 1 according to various embodiments of the present disclosure.

FIG. 3 is a flowchart illustrating one example of functionality implemented as portions of a distribution circuit and intelligent electronic device simulator application executed in a computing device in the networked environment of FIG. 1 according to various embodiments of the present disclosure.

FIG. 4 is a schematic block diagram that provides one example illustration of a computing device employed in the networked environment of FIG. 1 according to various embodiments of the present disclosure.

### DETAILED DESCRIPTION

The present disclosure relates to the simulation of electric utility distribution circuits containing simulated software intelligent electronic devices. Various embodiments of the present disclosure facilitate creation of distribution circuit models containing simulated software intelligent electronic devices. For example, in some embodiments, the distribution circuit and intelligent electronic device simulator application may be executed by a computing device. The distribution circuit and intelligent electronic device simulator application may be implemented as a stand-alone software application that permits a user to create distribution electric circuit models that contain user-created simulated software intelligent electronic devices. Profiles corresponding to the simulated software intelligent electronic devices may be created and modified by a user and stored to a database for access by the distribution circuit and intelligent electronic device simulator application.

The distribution circuit and intelligent electronic device simulator application may use a configuration file to load the filenames and file locations of the user-created software intelligent electronic device databases. Once the simulated software intelligent electronic devices have been created and stored to a database, the distribution circuit and intelligent electronic device simulator application accesses the database and facilitates creation of circuit models containing the simulated software intelligent electronic devices. In one embodiment, the simulated software intelligent electronic devices are recognized by the automated recovery system as actual field (rather than simulated) intelligent electronic devices. The automated recovery system responds to the distribution circuit model by sending distributed network protocol (DNP) poll requests and/or DNP command messages to the simulated software intelligent electronic devices when the simulated circuit models are representative of a problem on a power line. Subsequently, the distribution circuit and intelligent electronic device simulator application updates the simulated software intelligent electronic devices in response to the command messages from the automated recovery system. In the following discussion, a general description of the system and its components is provided, followed by a discussion of the operation of the same.

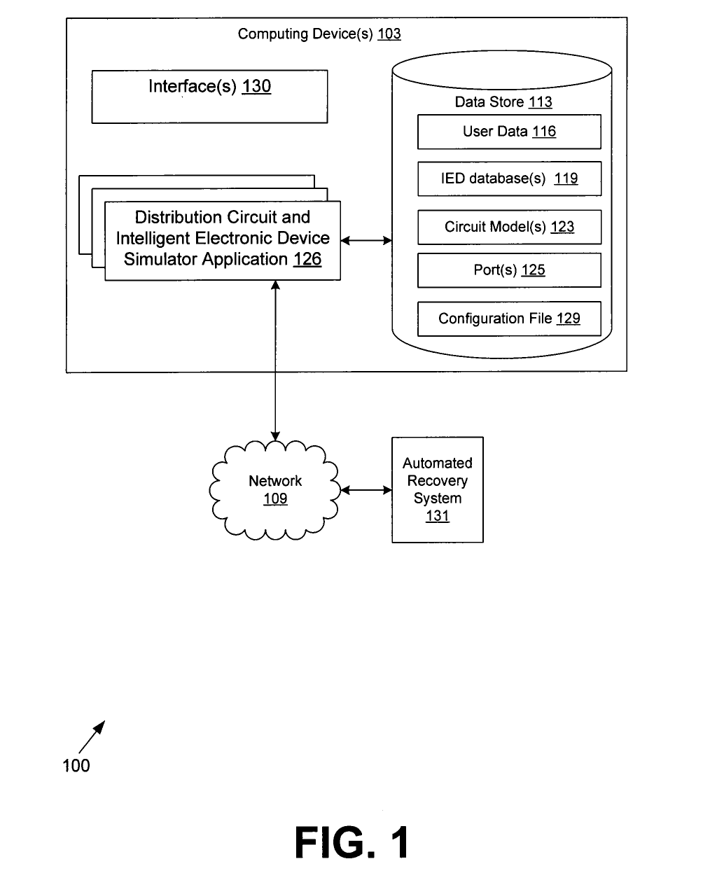

With reference to FIG. 1, shown is a networked environment 100 according to various embodiments. The networked environment 100 includes a computing device 103, and network 109. The network 109 includes, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

Various applications and/or other functionality may be executed in the computing device 103 according to various embodiments. Also, various data is stored in a data store 113 that is accessible to the computing device 103. The data store 113 may be representative of a plurality of data stores as can be appreciated. The data stored in the data store 113, for example, is associated with the operation of the various applications and/or functional entities described below.

The components executed on the computing device 103, for example, include a distribution circuit and intelligent electronic device simulator application 126, and/or other applications, services, processes, systems, engines, or functionality not discussed in detail herein. The distribution circuit and intelligent electronic device simulator application 126 is executed to simulate electronic circuit models containing software intelligent electronic devices created by a user. Additionally, the distribution circuit and intelligent electronic simulator application 126 utilizes a configuration file 129. The configuration file 129 is executed to load the filenames and file locations of the user-created simulated software intelligent electronic device databases 119. The distribution circuit and intelligent electronic device simulator application 126 may communicate with the automated recovery system 131, over various protocols, such as, for example, distributed network protocol (DNP) and/or other protocols for communicating data over the network 109.

The data stored in the data store 113 includes, for example, user data 116, intelligent electronic device (“IED”) databases 119, circuit model(s) 123, port(s) 125 and potentially other data. User data 116 includes various data associated with a user that employs computing device 103 to interact with the distribution circuit and intelligent electronic device simulator application 126. User data 116 may include user information such as, usernames, passwords, security credentials, authorized applications, and/or other data. IED databases 119 may include information such as, for example, status, analog, pulse, command, command rules, and/or other information associated with each IED. Circuit model(s) 123 may include distribution electronic circuit models created by a user employing a computing device 103 that contain user created simulated software IEDs. Port(s) 125 may include the ports that are available for use by the simulated software IEDs.

The computing device 103 is representative of a plurality of client devices that may be coupled to the network 109. The computing device 103 may comprise, for example, a processor-based system such as a computer system. Such a computer system may be embodied in the form of a desktop computer, a laptop computer, tablet computer systems, and/or other devices with like capability.

In addition, the automated recovery system 131 includes a plurality of automatic electric circuit restoration devices that may be coupled to a network 109. The automated recovery system 131 may be configured to communicate with the distribution circuit and intelligent electronic simulator application 126 executed in the computing device 103 over a network 109. For example, the automatic recovery system 131 may send DNP poll requests that cause the simulated software IEDs to respond with a poll response. A poll response is a message that usually contains status and analog data describing the simulated software IED. Additionally, the automatic recovery system may send DNP command messages to the simulated software IED that may cause the simulated software IED to modify internal status points based on the command rules associated with IED databases 119. In another embodiment, a user employing the distribution circuit and electronic device simulator application 126 may modify the status values of a simulated software IED that would result in other actions by the automated recovery system 131.

Next, a general description of the operation of the various components of the networked environment 100 is provided. To begin, a user at a computing device 103 may send a request to a computing device 103 to launch the distribution circuit and intelligent electronic device simulator application 126. The computing device 103 executes the distribution circuit and intelligent electronic device simulator application 126 in response to the appropriate input. On first access, the distribution circuit and intelligent electronic device simulator application 126 may facilitate the creation of user data 116 by providing one or more interfaces 130 for establishing the user data 116 if the user data 116 has not already been established. For instance, the distribution circuit and intelligent electronic device simulator application 126 may prompt the user to indicate a name for the user data 116, a password for the user data 116, and/or any other parameter or user information for establishing the user data 116.

Additionally, the distribution circuit and intelligent electronic device simulator application 126 may facilitate the creation of simulated software intelligent electronic devices. For instance, the distribution circuit and intelligent electronic device simulator application 126 may prompt the user to input information relating IED databases 119. In one embodiment, a user employing a computing device 103 may indicate IED status values, IED analog values, IED pulse values, IED command data, IED command rule data, and/or any other parameter or IED information for establishing IED database 119. The distribution circuit and intelligent electronic device simulator application 126 may then access the configuration file 129 to load the filenames and file locations associated with the IED databases 119. In one embodiment, the distribution circuit and intelligent electronic device simulator application 126 may prompt a user employing a computing device 103 to modify the configuration file 129 by providing the filenames and file locations associated with IED databases 119 through use of an input device such as, for example, a keyboard, touch screen, and/or any other devices that can provide user input.

Next, the distribution circuit and intelligent electronic device simulator application 126 may facilitate the creation of at least one circuit model 123 by a user employing a computing device 103. In one embodiment, the distribution circuit and intelligent electronic device simulator application 126 may have two modes of operation: a first mode and a second mode. For instance, the distribution circuit and intelligent electronic device simulator application 126 may be executed in a first mode to enable a user employing a computing device 103 to create, edit, and/or otherwise modify at least one circuit model 123. Each circuit model 123 may be stored for later access by the distribution circuit and intelligent electronic device simulator application 126. Each circuit model may contain at least one of the simulated software IEDs that may be retrieved from IED databases 119. Each of the simulated software IEDs may be configured to mimic the operation of actual IEDs on a power line. In one embodiment, a user employing a computing device 103 defines at least one port 125 and selects at least one of the simulated software IEDs from IED databases 119. As a non-limiting example, each port 125 may be associated with a respective one of the simulated software IEDs. In another embodiment, the automated recovery system 131 sends at least one DNP poll request or DNP command message to the distribution circuit and intelligent electronic device simulator application 126 when at least one circuit model is representative of an outage, a power failure, and/or other loss of power on at least one power line.

In another embodiment, the distribution circuit and intelligent electronic device simulator application 126 publishes a real time communications trace between the automated recovery system 131 and at least one of simulated software IEDs to a computing device 103 over a network 109. The real time communications trace may display DNP Protocol messages transmitted between the automated recovery system 131 and the at least one of the simulated software IEDs in the form of a user interface 130 to a computing device 103 over a network 109. Additionally, the distribution circuit and intelligent electronic device simulator application 126 may permit a user employing a computing device 103 to suspend the publication of the real time communications trace. In another embodiment, the distribution circuit and intelligent electronic device simulator application 126 permits a user employing computing device 103 to disable communication over the network 109 between the automated recovery system 131 and the simulated software IED.

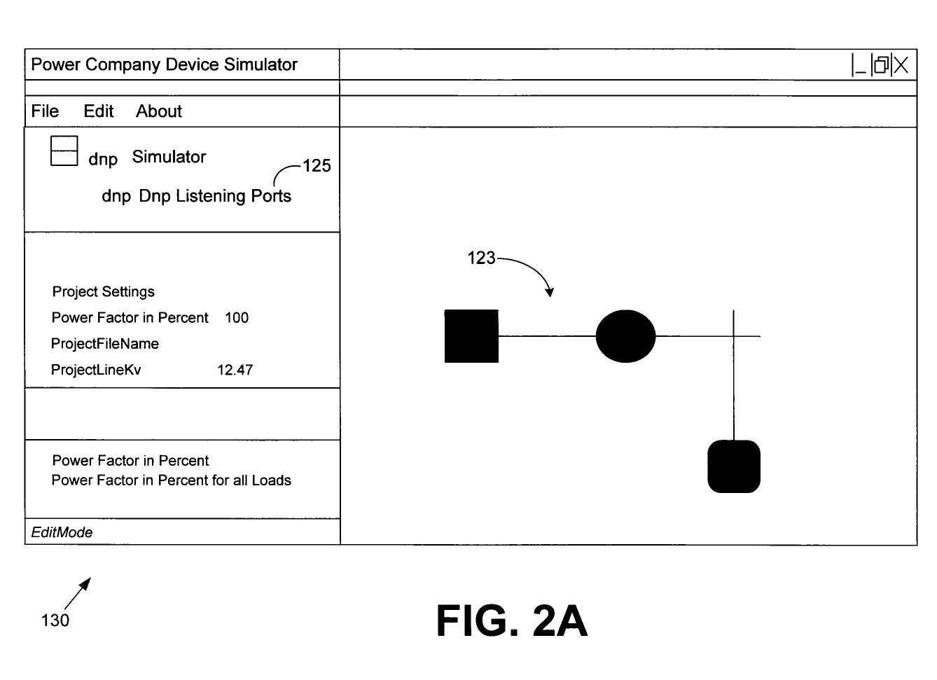

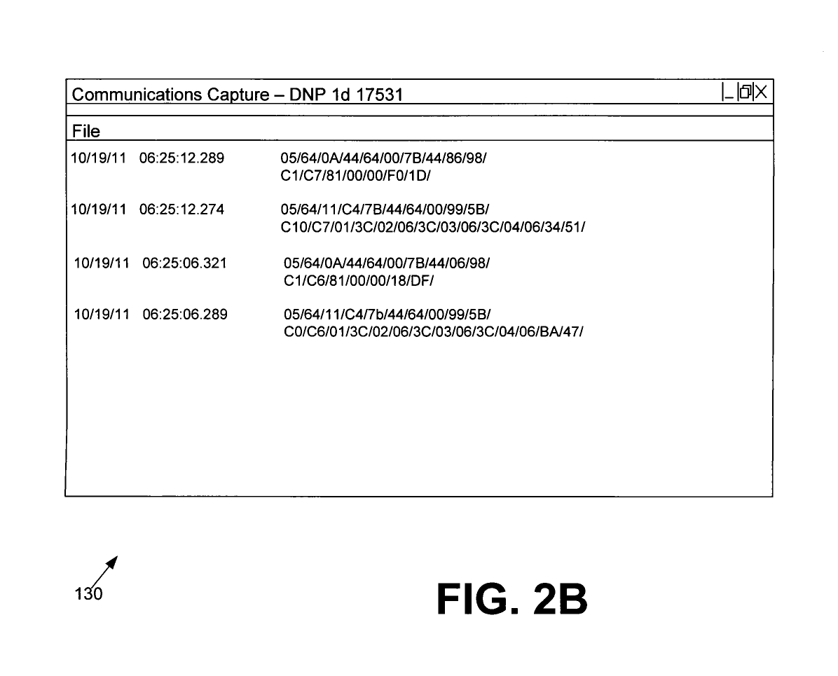

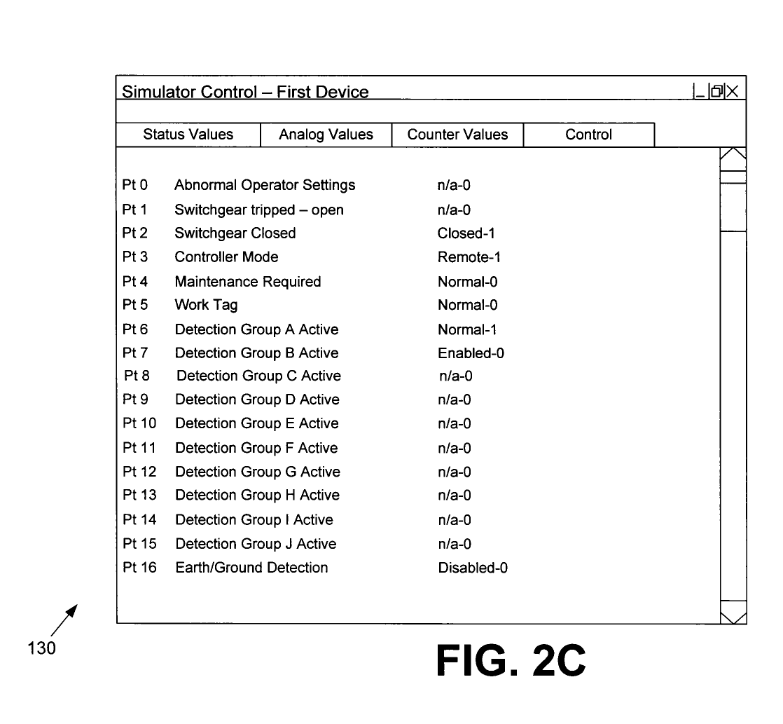

Referring next to FIG. 2A, shown is one example of a window of the distribution circuit and intelligent electronic device simulator application 126 rendered in the form of a user interface 130 (FIG. 1) executed in a computing device 103 (FIG. 1) in the networked environment 100 (FIG. 1). In this non-limiting example, the window shows three panes. The large pane 203 on the right side is where the circuit models 123 are constructed by a user employing a computing device 103 and displayed in the user interface 131. The tree view 206 in the upper left pane defines the ports 125 the simulated software IEDs will use. The lower left pane 209 shows properties associated with a selected circuit element.

As shown, the view depicts the main window of the distribution circuit and intelligent electronic device simulator application 126 in the form of the user interface 130. Various screenshots and other descriptive information may also be provided in the user interface 130. The graphical components, such as circuit models 123 and ports 125, comprising information shown in FIG. 2A are merely examples of various types of features that may be used to accomplish the specific function noted. Thus, the distribution circuit and intelligent electronic device simulator application may be used by a variety of clients 106 (that are capable of transmitting data with acceptable bandwidth and latency over a network 109).

Turning now to FIG. 2B shown is an example of a real time communications trace window generated by the distribution circuit and intelligent electronic simulator application 126 rendered in the form of a user interface 130 executed in computing device 103 (FIG. 1) in the networked environment 100 (FIG. 1). In this non-limiting example, a user employing a computing device 103 may suspend the generation of the real time communications trace. In one embodiment, data related to the communication between the automated recovery system 131 and the simulated software IED is lost when the real time communications trace is suspended.

Moving on to FIG. 2C, shown is a view of a device control status window of the distribution circuit and intelligent electronic device simulator application 126 rendered in the form of a user interface 130 executed in a computing device 103 (FIG. 1) in the networked environment 100 (FIG. 1). The example of FIG. 2C depicts the current data values of the status, analog, counter, and/or other data values associated with the simulated software IED.

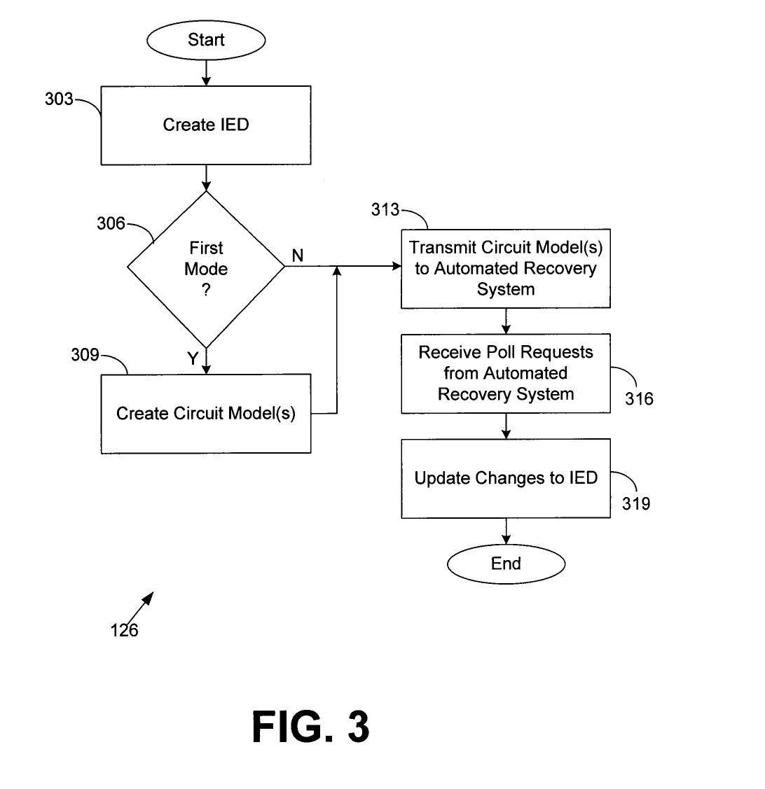

Referring next to FIG. 3, shown is a flowchart that provides one example of the operation of a portion of the distribution circuit and intelligent electronic device simulator application 126 according to various embodiments. It is understood that the flowchart of FIG. 3 provides merely an example of the many different types of functional arrangements that may be employed to implement the operation of the portion of the distribution circuit and intelligent simulator application 126 as described herein. As an alternative, the flowchart of FIG. 3 may be viewed as depicting an example of steps of a method implemented in the computing device 103 (FIG. 1) according to one or more embodiments.

Beginning with step 306, the distribution circuit and intelligent electronic device simulation application 126 determines which mode of operation has been selected by a user employing a computing device 103. If the mode of operation does not correspond to a first mode, the distribution circuit and intelligent electronic device simulator application 126 moves to step 313 as will be discussed herein. Assuming a first mode has been selected, the distribution circuit and intelligent electronic device simulator application 126 proceeds to step 309. In step 309, the distribution circuit and intelligent electronic device simulator application 126 facilitates the creation of circuit models 123 (FIG. 1) which may contain at least one simulated software IED.

Next, the distribution circuit and intelligent electronic device simulator application 126 proceeds to step 313. In step 313, the distribution circuit and intelligent electronic device simulator application 126 receives DNP poll requests and/or DNP command messages from the automated recovery system 131. The distribution circuit and intelligent electronic device simulator application 126 then proceeds to step 316. In step 316, the distribution circuit and intelligent electronic device simulator application 126 responds with a poll response which may contain status and analog data describing the simulated software IED. In box 319, the distribution circuit and electronic device simulator application 126 determines whether an input to cancel the distribution circuit and electronic device simulator application is received. If the distribution circuit and electronic device simulator application 126 has not received an input to cancel then the distribution circuit and electronic device simulator application 126 proceeds to box 306 as described above. Otherwise, the distribution circuit and intelligent electronic device simulation applicator 126 ends.

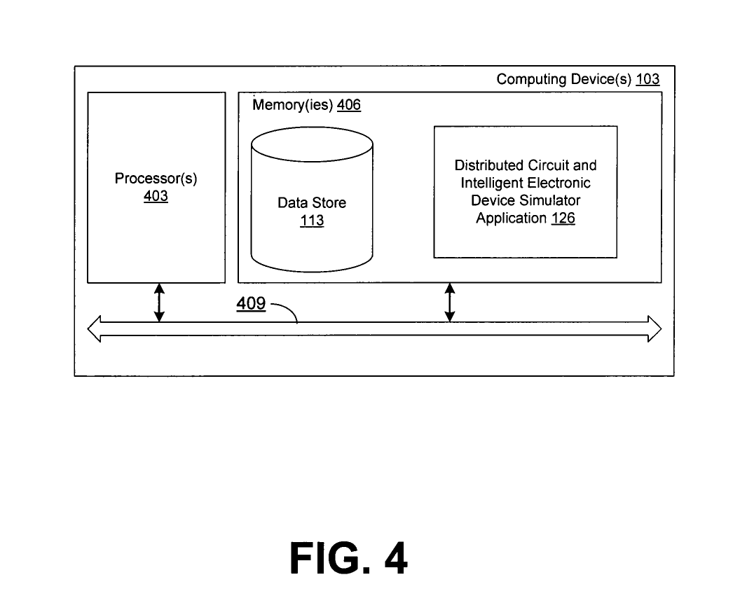

With reference to FIG. 4, shown is a schematic block diagram of the computing device 103 according to an embodiment of the present disclosure. The computing device 103 includes at least one processor circuit, for example, having a processor 403 and a memory 406, both of which are coupled to a local interface 409. To this end, the computing device 103 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the distribution circuit and intelligent electronic simulator application 126, and potentially other applications. Also stored in the memory 406 may be a data store 113 and other data. In addition, an operating system may be stored in the memory 406 and executable by the processor 403.

It is understood that there may be other applications that are stored in the memory 406 and are executable by the processors 403 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and the memory 406 may represent multiple memories 406 that operate in parallel processing circuits, respectively. In such a case, the local interface 409 may be an appropriate network 109 (FIG. 1) that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the distribution circuit and intelligent electronic device simulator application 126, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the distribution circuit and intelligent electronic device simulator application 126. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the distribution circuit and intelligent electronic device simulator application 126 that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, the program comprising:
code that receives an input from the client, wherein the input causes a simulator application to enter a first mode or a second mode;
code that facilitates creation of a plurality of circuit models when the simulator application enters the first mode, wherein each circuit model is representative of an electrical circuit;
code that facilitates simulation of the circuit models, each of the circuit models comprising:
at least one source object;
at least one load object;
at least one horizontal line segment;
at least one vertical line segment; and
at least one user-created software intelligent electronic device,
wherein the user-created software intelligent electronic device further comprises a plurality of status points corresponding to a plurality of operational modes associated with a hardware intelligent electronic device;
code that stores the circuit models;
code that receives at least one distributed network protocol message from an automated recovery system when the simulator application enters a second mode;
code that transmits at least one poll response to the automated recovery system in response to the at least one distributed protocol message;
code that publishes a real time communications trace between the automated recovery system and the at least one user-created software intelligent electronic device; and
code that facilitates a user manipulation of at least one status point.

2. The computer-readable medium of claim 1, further comprising code that disables communication between the at least one user-created software intelligent electronic device and the automated recovery system.

3. The computer-readable medium of claim 1, further comprising code that suspends a publication of the real time communications trace.

4. A system, comprising:
at least one computing device; and
a simulator application executable in the at least one computing device, the simulator application comprising:
logic that receives an input from the client, wherein the input causes the simulator application to enter a first mode or a second mode;
logic that facilitates creation of a plurality of circuit models when the simulator application enters the first mode, wherein each circuit model is representative of an electrical circuit;
logic that facilitates the simulation of the circuit models, each of the circuit models comprising:
at least one source object;
at least one load object;
at least one horizontal line segment;
at least one vertical line segment; and
at least one user-created software intelligent electronic device, wherein the user-created software intelligent electronic device further comprises a plurality of status points corresponding to a plurality of operational modes associated with a hardware intelligent electronic device;
logic that receives at least one distributed network protocol message from an automated recovery when the simulator application enters a second mode;
logic that transmits at least one poll response to the automated recovery system in response to the distributed network protocol message;
logic that publishes a real time communications trace between the automated recovery system and the at least one user created software intelligent electronic device; and
logic that facilitates a user manipulation of at least one status point.

5. The system of claim 4, wherein the distributed network protocol message corresponds to a distributed network protocol poll request.

6. The system of claim 5, wherein the distributed network protocol messages corresponds to a distributed network protocol command message.

7. The system of claim 4, further comprising logic that stores information relating to the circuit models.

8. The system of claim 7, further comprising logic that retrieves information relating to the circuit models.

9. The system of claim 4, further comprising logic that disables communication between the at least one user-created software intelligent electronic device and the automated recovery system.

10. The system of claim 4, further comprising logic that publishes a real time communications trace between the automated recovery system and the at least one user-created software intelligent electronic device.

11. The system of claim 10, further comprising logic that suspends a publication of the real time communications trace.

12. A method, comprising the steps of:
receiving, in the at least one computing device, an input from that client, wherein the input causes a simulator application to enter a first mode or a second mode;
facilitating, in the at least one computing device, creation of a plurality of circuit models when the simulator application enters the first mode, wherein each circuit model is representative of an electrical circuit;
facilitating, in the at least one computing device, simulation of the circuit models, each of the circuit models comprising:
at least one source object;
at least one load object;
at least one horizontal line segment;
at least one vertical line segment; and
at least one user-created software intelligent electronic device;
wherein the user-created software intelligent electronic device further comprises a plurality of status points corresponding to a plurality of operational modes associated with a hardware intelligent electronic device
communicating, in the at least one computing device, at least one distributed network protocol message from the automated recovery system to the simulator application when the simulator application enters a second mode;
communicating, in the at least one computing device, at least one poll response from the simulator application to the automated recovery system; and
generating, in the at least one computing device, at least one change to at least one user created software intelligent electronic device in response to the distributed network protocol message.

13. The method of claim 12, further comprising the step of facilitating, in the at least one computing device, a user manipulation of at least one status point.

14. The method of claim 12, further comprising the step of storing, in the at least one computing device, information relating to the at least one circuit model.

15. The method of claim 14, further comprising the step of retrieving, in the at least one computing device, information relating to the at least one circuit model.

16. The method of claim 12, further comprising the step of storing, in the at least one computing device, information relating to the at least one circuit model.

17. The method of claim 16, further comprising the step of retrieving, in the at least one computing device, information relating to the at least one circuit model.

18. The method of claim 12, further comprising the step of disabling, in the at least one computing device, communication between the at least one user created software intelligent electronic device and the automated recovery system.

19. The method of claim 12, further comprising the step of publishing, in the at least one computing device, a real time communications trace between the automated recovery system and the at least one user created software intelligent device.

20. The method of claim 19, further comprising the step of suspending, in the at least one computing device, a publication of the real time communications trace.
